(19) United States
(12) Patent Application Publication
(10) Pub. No.: US 2026/0044870 A1
(43) Pub. Date: Feb. 12, 2026

(54) SYSTEM AND METHOD USING DEEP LEARNING AND MACHINE LEARNING TO PREDICT THE LIKELIHOOD OF A SUPPLIER-BUYER RELATIONSHIP BETWEEN TWO ENTITIES AND TO GENERATE A PROBABILITY INDEX THEREFROM

(71) Applicant: THE DUN AND BRADSTREET CORPORATION, Jacksonville, FL (US)

(72) Inventors: Andrew Byrnes, Arlington, VA (US); Mark Selss, Ijamsville, MD (US); Charlie DeCell, Washington, DC (US); Amber Jaycocks, Palos Verdes Pe, CA (US); Adrienne Lamoureux, Herndon, VA (US)

(73) Assignee: THE DUN AND BRADSTREET CORPORATION, Jacksonville, FL (US)

(21) Appl. No.: 19/290,802

(22) Filed: Aug. 5, 2025

Related U.S. Application Data
(60) Provisional application No. 63/679,724, filed on Aug. 6, 2024.

(51) Int. Cl. G06Q 30/0202; G06Q 30/0201

(52) U.S. Cl. CPC G06Q 30/02022; G06Q 30/02011

(57) ABSTRACT

A system and method for utilizing deep learning and machine learning to predict the likelihood of a supplier-buyer relationship existing between two business entities using a retrieval model and a ranking model. The output is a raw supplier propensity score between 0 and 1 representing the likelihood of a supplier-buyer relationship, as well as a propensity class based on ranges of this score. A user-interactive map displays supplier-buyer relationships where the raw supplier propensity score exceeds a threshold value.

### CROSS-REFERENCED APPLICATION

This application is a non-provisional application of U.S. provisional application No. 63/679,724, filed on Aug. 6, 2024, which is incorporated by reference thereto in its entirety.

### BACKGROUND

### 1. Field of the Disclosure

The present disclosure relates to a method using deep learning and machine learning methods to predict the likelihood that given two businesses, one contains a supplier relationship with the other.

### 2. Description of the Related Art

Establishing whether two businesses maintain a supplier-buyer relationship is critical for accurate assessments of creditworthiness and operational stability. However, this information is not always available or reported for analysis. There is a need for objective, consistent, and holistic means to assess the likelihood of supplier and buyer relationships using probabilistic machine learning.

Supply chains have an impact on the performance of a buyer's business. Delays or disruptions to a supplier can have a cascading impact on the operations of the buyer's business. The problem is that these supply chains are obscure and a buyer does not have a transparent view of their supply chains beyond their immediate suppliers. Conventional systems have limitations regarding supply chain connections which are limited in the number of connections that they could score in a reasonable amount of time. For example, if a scoring universe has tens of millions of suppliers and tens of millions of buyer businesses and if each business is in theory able to supply each buyer than it would be required to score tens of millions of suppliers times tens of millions of buyers possible connections. This results in quadrillions of scores. Using conventional machine learning models to score each of these possible connections would take years to score.

The present disclosure involves a supplier propensity index which attempts to solve this problem by creating a predictive model to map out all the supply chains of any of buyer's businesses across the globe. That is, the present disclosure attempts to overcome the hurdles of the conventional technology by applying a two-stage modeling approach that scales to meet the demands of the problem while still providing accurate predictions. Using the two-stage modeling approach of the present disclosure, the present inventors have discovered that they can score this universe of suppliers and buyers in less than one (1) week.

This disclosure addresses these issues by describing a method of using deep learning and machine learning, trained on firmographic data, to predict the likelihood that a supplier-buyer relationship exists between two businesses.

### SUMMARY

The novel supplier propensity index (output) of the present disclosure overcomes the deficiencies of the conventional technology by applying a unique two-stage modeling approach that scales to meet the demands of the conventional problem while still providing accurate predictions. This two-stage modeling approach of the present disclosure includes a first stage (i.e., retrieval model) which selects the top-k candidates for each query and a second stage (i.e., ranking model), then scores and sorts those candidates from most likely to least likely. This framework is applied to supply chains where the candidates are the suppliers and the queries are the buyers such that we seek the top-k most likely suppliers for each buyer in the retrieval model.

In general, an embodiment of the disclosure is directed to a method of predicting the likelihood of a supplier-buyer relationship existing between two business entities, comprising the steps of collecting a population of buyers and suppliers using firmographic data, filtering that data by predetermined criteria, generating a list of no greater than k (where k defaults to 1000) candidate suppliers for each buyer through the use of a retrieval model, and then ranking those candidate suppliers by the likelihood they are a supplier to each buyer using a ranking model.

The present disclosure is also directed to a system for predicting the likelihood of a supplier-buyer relationship existing between two business entities, comprising: a first apparatus including programmed digital processors working in a parallel processing architecture to generate a list of no greater than k (where k defaults to 1000) candidate suppliers for each buyer using a deep learning model, and a second apparatus including programmed digital processors working in a parallel processing architecture to rank the likelihood that each candidate supplier is a supplier to a buyer according to a machine learning model. A user-interface hosted in a cloud computing environment and transmitted to users over the internet displays a map which illustrates the existence of modeled supplier-buyer relationships between geographic locations of businesses.

A method for predicting the likelihood that two businesses have a supplier-buyer relationship comprising the steps of: collecting a population of buyers and suppliers by filtering firmographic data with a predetermined set of criteria, generating a list of no greater than k, where k defaults to 1000, candidate suppliers for each buyer using a retrieval model, and then ranking those businesses as candidate suppliers by the likelihood they have a supplier relationship to the buyer using a ranking model.

The method further comprises the assignment of a raw supplier propensity score drawn from a supplier's ranking to a buyer.

The method further comprising displaying the predicted supplier-buyer relationships on a user-interactive map, in which dotted lines represent modeled supplier-buyer relationships where the associated raw supplier propensity scores exceed a threshold value.

### BRIEF DESCRIPTION OF THE DRAWINGS

FIG. 1 is a process flow diagram illustrating the steps in the disclosed method.

FIG. 2 is an illustration of an interactive map dashboard displaying modeled supplier-buyer relationships.

FIG. 3 is another view of the process from FIG. 1, highlighting that each step further filters the initial dataset.

FIG. 4 depicts the two-tower deep learning model used in the retrieval model of FIG. 1.

FIG. 5 depicts output scores generated in FIG. 1.

FIG. 6 is a chart demonstrating potential end-use application of output scores.

A component or a feature that is common to more than one drawing is indicated with the same reference number in each of the drawings.

### DESCRIPTION OF THE EMBODIMENT

The Supplier Propensity Index predicts the likelihood that given any two businesses, Business A is a supplier of Business B. The goal of this score is to increase the number of supply chain relationships by using a probabilistic model, based on the information in a data cloud. To help evaluate the likelihood objectively and consistently, a large amount of business information is combined with expert analysis and statistical techniques to help determine likely supply chain connections to a business.

The integrity of the information contained in a data cloud is driven by the proprietary DUNSRight™ Quality Process (see U.S. Pat. No. 7,82,757, entitled System and Method for Providing Enhanced Information, which is incorporated herein by reference thereto in its entirety). The foundation of DUNSRight™ is data governance which includes automated and manual checks to ensure that data in the data cloud meets high standards.

The Supplier Propensity Index is designed to help predict supply chain relationships between two businesses whether for a customer analyzing their own supply chain or analyzing the supply chains of other businesses or industries. The score allows a user to:
Map a business's entire supply chain to uncover its tier-n suppliers.
Identify the most likely suppliers and uncover risks within those suppliers.
Analyze secondary and tertiary effects of business disruptions.
Monitor complex supply chains of industries or geographies.
Target risky suppliers.
Monitor aggregate trends across supply chains at the macro level.

The Supplier Propensity Index predicts the likelihood that given two businesses, that business A is a supplier to business B. This supervised two stage model is built using information in the data cloud on both business A and business B, signals data between the two businesses, and macroeconomic data.

A supply chain relationship is defined as having an observable and known supply chain connection between the two businesses within the previous 2 years. The resulting output from the Supplier Propensity Index is a buyer DUNS, a supplier DUNS, and their likelihood of supply chain connection.

The Supplier Propensity Index was developed using rigorous statistical techniques for all stages of the modeling process. This helps to ensure that the resulting model is stable and robust. The process of checks and balances also includes validation of the models on separate samples from external sources of supplier connections data to ensure the model performs outside of the D&B environments.

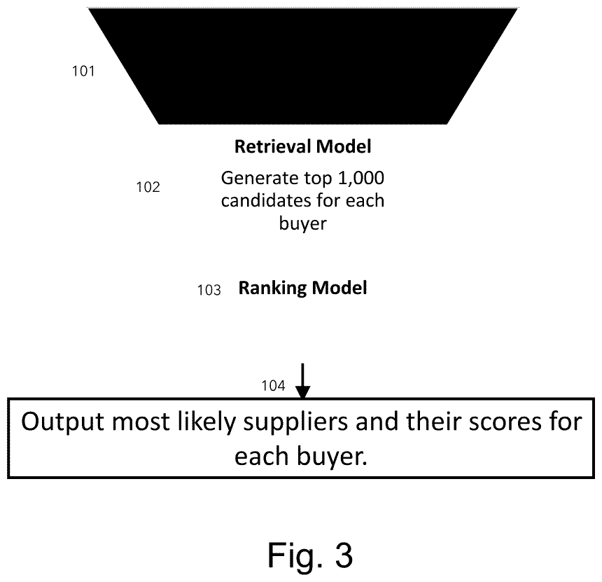

The build process for the Suppler Propensity Index utilizes a two-stage modeling approach where the first stage model retrieves the top-k candidate suppliers for each buyer and then the second stage model ranks those candidate suppliers in terms of their likelihood of being a supplier to the buyer business. This approach is used in recommender systems where there is both a large population of users and items that need to be efficiently evaluated and scored against each other. FIG. 3 shows how the modeling approach filters the populations of suppliers and buyers at each stage to output the most likely suppliers for each buyer.

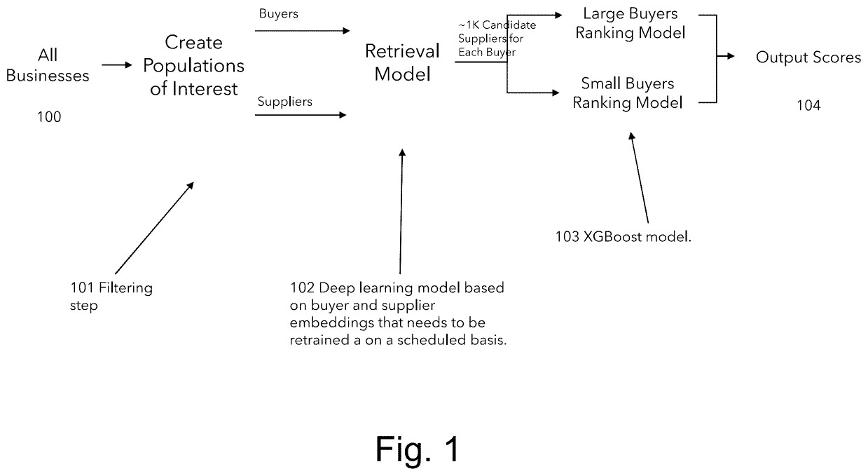

The end-to-end process as illustrated in FIGS. 1 and 3 begins with unfiltered firmographic data about businesses 100, where firmographic data includes items like business name, business age, industry information, total number of employees, total annual sales, and modeled data like credit scores and likelihood of on-time payment.

The first step of the embodiment is the creation of a population of interest for both buyers and suppliers, i.e., filtering step represented as 101, in which the raw firmographic data is filtered by a series of predetermined criteria. These criteria comprise removing the following from the dataset: inactive businesses, publicly administered businesses, businesses with unknown classification, branches of businesses, single site subsidiaries, non-employing companies, holding companies, sole proprietors, and businesses with less than five employees. The filtration occurs in a cloud-hosted parallel processing environment to take advantage of the computer power necessary to analyze exceptionally large datasets.

The resulting dataset makes up the population of candidate buyers and suppliers. The data is loaded into tables in a cloud-hosted parallel processing data warehouse for further analysis.

The step represented at 102 is the retrieval model, a two-tower deep learning model regularly retrained on up-to-date firmographic data for both buyers and suppliers. The primary target data for model training comprises observed credit inquiries between buyers and suppliers. Inquiries are a good target because they can be a proxy for trade such that a business will inquire upon another business prior to doing business to check their credit score and ability to repay for the goods and services exchanged.

The goal of this model is to map buyers and suppliers to the same embeddings space based on their interactions such that buyers are likely to interact with suppliers they are closest to in that space. Embeddings are calculated for both the buyer and supplier models to learn the interactions between the two sets. Once the buyers and suppliers are mapped to the same space, k-nearest-neighbors are calculated to find the closest k suppliers for each buyer.

As the retrieval model analyzes credit inquiries, it also analyzes other firmographic attributes of both suppliers and buyers to learn what descriptors are associated with various businesses' interactions. This learning allows the model to overcome the cold-start problem and create distinct embeddings for businesses on which it has not been trained.

The output of the retrieval model is a list of no greater than 1000 candidate suppliers for each buyer in the filtered dataset.

The step represented at 103 is the ranking model, which takes the 1000 or fewer candidate suppliers and ranks them by the likelihood of a supplier-buyer relationship.

The ranking model is trained on both events and non-events.

Events, which are defined as observable and known supply chain connections occurring within the past two years, are drawn from observed data comprised of macroeconomic data and the Dun & Bradstreet DataCloud.

Non-events, which comprise an unbiased sample of business relationships without a known supply chain connection, are randomly sampled.

To reduce the risk of bias in the dataset, sampling targets for suppliers and buyers are drawn from the distribution of the Organization for Economic Co-operation and Development (OECD) Input-Output tables.

For the observed supply chain connections sampled in the events dataset, an identifier is assigned to each buyer and supplier. For each identified buyer, two random suppliers are sampled as non-events. For each identified supplier, two random buyers are also sampled as non-events.

Based on the aforementioned OECD sampling targets, a stratified sampling approach is used to sample from the dataset of events and non-events to match the target distributions. The datasets are then combined, and duplicates are removed.

This analytical dataset is randomly segmented into mutually exclusive training, validation, and testing datasets. To improve model accuracy, the datasets are further segmented into those representing Large Buyers—or businesses with 100 or more employees—and Small Buyers—or businesses with less than 100 employees—as shown at 103.

A feature selection process is performed to narrow the list of predictor variables for the underlying model. Univariate analysis is conducted to evaluate the predictive power of independent variables with respect to the target variable. Coverage of predictor variables is assessed, and sparse predictor variables removed. Multicollinearity and redundant variables are reduced using variable clustering.

The result of this feature reduction process is a unique set of potential predictor variables that is tested in the model. For the model methodology, the XGBoost open-source decision tree machine learning library is used at 103, providing parallel tree boosting to solve problems in a fast and accurate way. XGBoost can also learn complex feature interactions from the associated firmographic data attributes. A random search hyperparameter tuning technique is used to find the best specification of hyperparameters for the algorithm based on the performance of the model on the development, validation, and testing datasets.

The output of this entire process at 104 is the raw supplier propensity score: a continuous decimal value between 0 and 1 for each relationship, in which 0 represents the lowest likelihood of a supplier-buyer relationship and 1 represents the highest likelihood of a supplier-buyer relationship.

A propensity class is further assigned to each relationship based on the raw score. Lowest Propensity, Moderate Propensity, High Propensity, and Highest Propensity represent ranges of the raw score value.

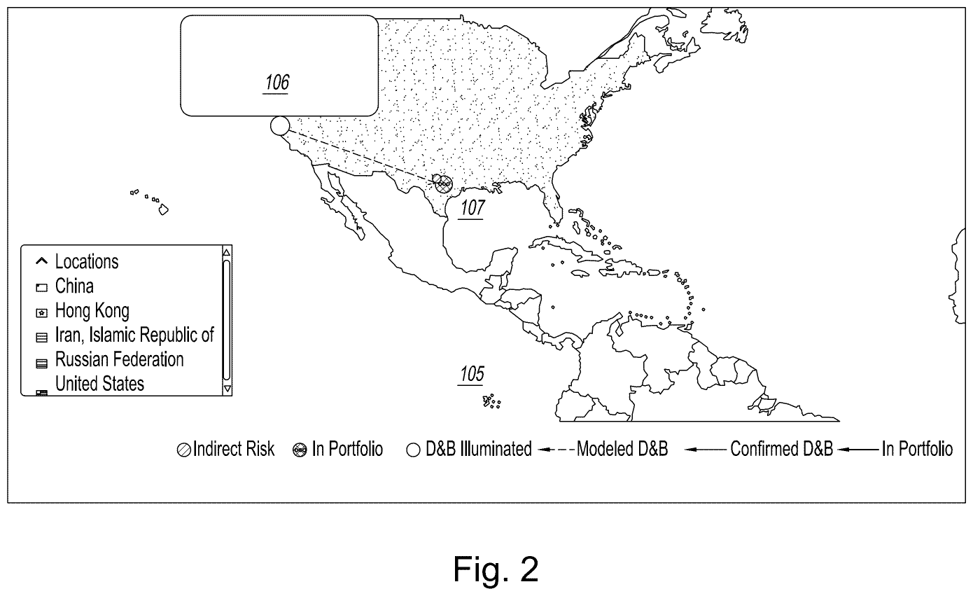

FIG. 2 illustrates a possible form of a dashboard containing an interactive map 105. Output data at 104 is read from data tables stored in a cloud computing environment, filtered according to a user's selections, and transmitted to end-users over the internet. Buyers and suppliers are labeled as pins on the map based on their primary business address—see, for example, the pins at 106 and 107.

A dotted line with an arrow is drawn between the buyer and supplier pins where a predicted relationship above a certain raw supplier propensity score threshold exists (for example, above a raw supplier propensity score of 0.9). The dotted line denotes a modeled relationship, whereas a solid line would represent an observed relationship. The arrow at the end of the line points from the predicted supplier to the predicted buyer.

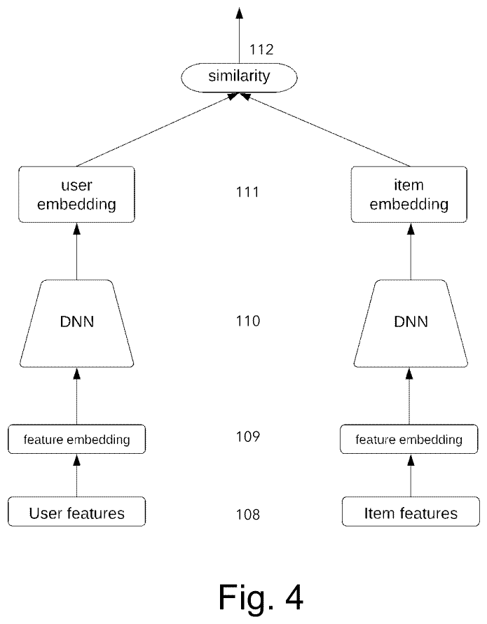

FIG. 4 depicts the two-tower deep learning model used in the retrieval model of FIG. 1. For candidate buyers and suppliers, each represented as a tower in the two-tower model, demographic, location, and business health features are input into the model as represented at 108. The models are trained on the input features at 109, to create respective buyer and supplier embeddings for each candidate buyer and supplier. Deep neural networks, represented as “DNN” at 110, train on the aforementioned embeddings in order to generate predictive ability. New embeddings are created at 111 as an output of the deep neural networks' training. This comprises a feature reduction to improve model performance. The supplier and buyer embeddings are compared at 112 to produce the top-k candidate suppliers for each buyer.

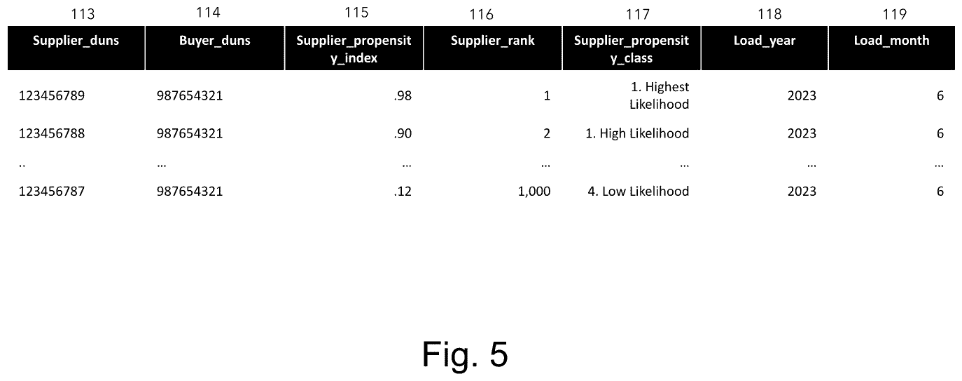

FIG. 5 depicts output scores generated in FIG. 1. The input supplier and buyer DUNS identifiers are depicted at 113 and 114, respectively. The raw supplier propensity score as between that specific supplier and buyer is shown as a decimal value between 0-1 at 115. The integer value at 116 represents the ranked likelihood that the candidate supplier is a supplier of that buyer as compared to the 1000 or fewer candidate suppliers. The supplier propensity class, a textual descriptor representing a range of raw supplier propensity score values, is represented at 117, 118 and 119 depict the year and month of the dataset, respectively.

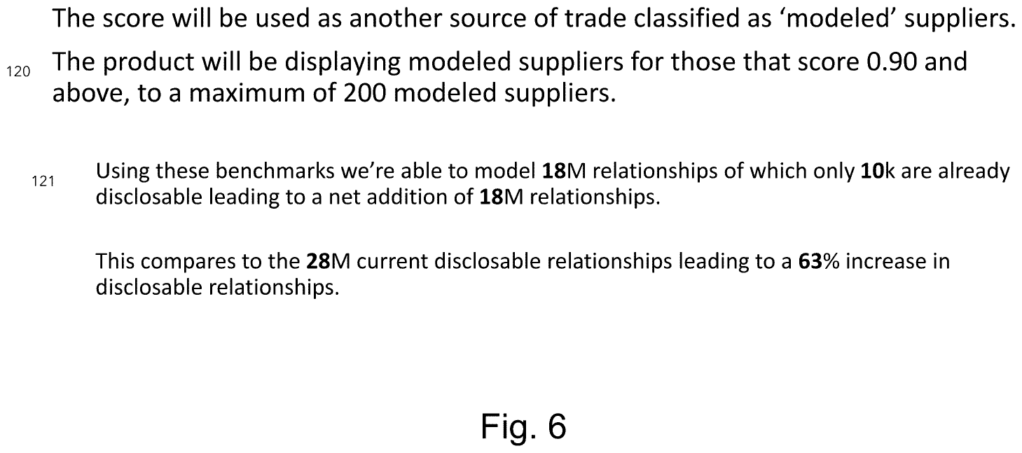

FIG. 6 is a chart demonstrating potential end-use application of output scores. The description at 120 demonstrates that the user-facing product treats raw supplier propensity scores above 0.90 as modeled buyer-supplier relationships. 121 illustrates that the use of this modeling process exponentially increases the number of reportable supply chain relationships.

The following is a list of some of the data elements used to evaluate the propensity of a supply chain connection between two businesses.

| DATA TYPE | FACTOR |
|---|---|
| Demographic/ | Age of Business of Supplier/Buyer |
| Public Records | Number of Total Employees of Supplier/Buyer |
| Information | Total Annual Sales of Supplier/Buyer |
| Business Health | Viability Score of Supplier/Buyer |
| | Portfolio Comparison of Supplier/Buyer |
| Inquiries | Total Inquiries between Supplier and Buyer |
| | Total Inquiries between Supplier and Buyer |
| | Location |
| | Derived Inquiry Variables based on the number of |
| | inquiries from the location of the buyer to that |
| | of the supplier |
| Linkage Information | Subsidiary Indicator of Supplier/Buyer |
| Industry Information | Industry NAICS Code of Supplier/Buyer |

The following is a list of some of the data elements used in developing the two-tower retrieval model.

| DATA TYPE | FACTOR |
|---|---|
| Demographic/ | Age of Business of Supplier/Buyer |
| Public Records | Number of Total Employees of Supplier/Buyer |
| Information | Industry of Supplier/Buyer |
| | Total Annual Sales of Supplier/Buyer |
| Location | State of Supplier/Buyer |
| Business Health | Delinquency Score of Supplier/Buyer |

The model is segmented into small buyer and large buyer models in order to improve model performance and accuracy. Validation testing has shown that splitting the model into these segments produces more accurate results.

The techniques described herein are exemplary and should not be construed as implying any limitation on the present disclosure. Various alternatives, combinations, and modifications could be devised by those skilled in the art. The present disclosure is intended to embrace all such alternatives, modifications, and variances that fall within the scope of the appended claims.

The terms “comprises” or “comprising” are to be interpreted as specifying the presence of the stated features, integers, steps or components, but not precluding the presence of one or more other features, integers, steps,

What is claimed is:

1. A method for predicting the likelihood that two businesses have a supplier-buyer relationship comprising the steps of:
collecting a population of buyers and suppliers by filtering firmographic data with a predetermined set of criteria, generating a list of no greater than k candidate suppliers for each buyer using a retrieval model, and then ranking those candidate suppliers by the likelihood they have a supplier relationship to the buyer using a ranking model.

2. The method of claim 1, further comprising the assignment of a raw supplier propensity score drawn from a supplier's ranking to a buyer.

3. The method according to claim 1, further comprising displaying the predicted supplier-buyer relationships on a user-interactive map, in which dotted lines represent modeled supplier-buyer relationships where the associated raw supplier propensity scores exceed a threshold value.

4. The method according to claim 1, wherein k defaults to 1000.

5. A system that predicts the likelihood that two businesses have a supplier-buyer relationship comprising:
a first apparatus including programmed digital processors working in a parallel processing architecture to generate a list of no greater than k candidate suppliers for each buyer using a deep machine learning model, and
a second apparatus including programmed digital processors working in a parallel processing architecture to rank the likelihood each candidate supplier is a supplier of a buyer according to a deep machine learning model.

6. The system accordingly to claim 5, wherein k defaults to 1000.

7. A system that predicts the likelihood that two businesses have a supplier-buyer relationship comprising:
storage memory having a list of businesses;
a filter which creates a population of interest for both buyers and suppliers;
a two-tower retrieval model that maps both said buyers and suppliers to the same embeddings space based on their interactions such that said buyers are likely to interact with suppliers that they are closest to in a featured space, thereby generating candidate suppliers for each said buyer; and
a ranking model which leverages development, validation, and testing of said candidate suppliers for each said buyer, and thereafter outputting a supplier propensity index score.
